(19) United States
(12) Patent Application Publication
(10) Pub. No.: US 2009/0235567 A1
(43) Pub. Date: Sep. 24, 2009

(54) Fuel Filler Pipe Information Collar for Fuel Type Identification

(75) Inventor: Brian Thomas Aitken, Livonia, MI (US)

Correspondence Address: ALLEMAN HALL MCCOY RUSSELL & TUTTLE, LLP, 806 S.W. BROADWAY, SUITE 600, PORTLAND, OR, 97205, US

(73) Assignee: FORD GLOBAL TECHNOLOGIES, LLC, Dearborn, MI (US)

(21) Appl. No.: 12/050,488

(22) Filed: Mar. 18, 2008

(51) Int. Cl. G09F 3/08

(52) U.S. Cl. 40/591; 29/525

(57) ABSTRACT

A fuel type information collar is provided. The fuel type information collar is configured to engage an outer perimeter of a fuel tank filler pipe assembly of an automotive vehicle. It may include an inner perimeter defining an aperture configured to engage the outer perimeter of the fuel tank filler pipe assembly. It may additionally include a top surface including indicia of fuel type information for indicating type of fuel to be used by the automotive vehicle. It may further include a plurality of radial finger cuts angularly spaced around the inner perimeter, the plurality of radial finger cuts forming a plurality of fingers that engage the outer perimeter of the fuel tank filler pipe assembly.

### BACKGROUND AND SUMMARY

Drivers of today's vehicles may have numerous available fuels to choose from at the fuel station. For example, various alternative fuels, such as ethanol based fuels, for one example E85, which contains 85% ethanol and 15% gasoline, are becoming available in the marketplace. Some vehicles, such as flexible fuel vehicle (FFV) vehicles, are specially designed and manufactured to be able to operate with gasoline, E85, or some combination thereof. Other vehicles may be configured to operate solely with gasoline.

An SAE Recommended Practice for informing a driver the type of fuel that may be used by his/her vehicle is through the use of colored fuel caps. For example, a yellow fuel cap with “E85/Gasoline” on it indicates to a driver that either E85 or unleaded gasoline may be used. A green fuel cap with “Diesel” on it shows a driver that diesel fuel is used. A black fuel cap, which is not required to have any words, may be used as a generic fuel cap, or may be used only for unleaded gasoline fueled vehicles. Thus, a black fuel cap may be used on FFV, diesel or gasoline burning vehicles. Therefore, a black fuel cap may not determinatively indicate the available fuel types that can be used with the vehicle.

Various approaches have been used to identify appropriate fuels for a vehicle, such as to add additional printed information to fuel caps. However, such an approach may be limited because of the various logo and directions that are already present on the fuel caps. For example, the required English, French and Spanish “Tighten Until Clicks” directions coupled with other logos may fill all the available space on the cap, or the font size used may become too small to be legibly printed using pad printing technique. In addition, attaching labels containing printed information regarding the type of fuel used to the fuel door, for example on the inside of the fuel door, may not be helpful, since customers often do not see or read these labels.

To at least partially address the above mentioned issues, a fuel type information collar is provided. The fuel type information collar is configured to engage an outer perimeter of a fuel tank filler pipe assembly of an automotive vehicle. It may include an inner perimeter defining an aperture configured to engage the outer perimeter of the fuel tank filler pipe assembly. It may additionally include a top surface including indicia of fuel type information for indicating type of fuel to be used by the automotive vehicle. It may further include a plurality of radial finger cuts angularly spaced around the inner perimeter, the plurality of radial finger cuts forming a plurality of fingers that engage the outer perimeter of the fuel tank filler pipe assembly.

By providing a fuel type information collar positioned at the fuel filler pipe inlet, the fuel type information is displayed at a visual point of a driver having sufficient display space, allowing the driver to more easily see the types of fuel allowed for the vehicle. Further, one example configuration provides an interference fit via a plurality of tapered fingers with a lead-in angle to thereby enable the collar to be more easily installed, yet still difficult to remove. In this way, the collar may be more permanently attached to the vehicle to reduce dislodgement. In addition, the interference fit of the fingers may also keep the collar from rattling when the vehicle is moving to thereby reduce any potential noise and/or vibration.

Further still, by forming the fuel type information collar in a disk shape with a center hole, it may have increased manufacturability, for example through an injection molding process.

Note that these are merely some of the potential features that can be achieved.

The inventor herein has recognized the above issues, available approaches, and potential features.

### BRIEF DESCRIPTION OF THE DRAWINGS

FIG. 1 illustrates a fuel type information system of an automotive vehicle, the fuel type information system including a first embodiment of a fuel type information collar engaged to a fuel tank filler pipe of the automotive vehicle.

FIG. 2 illustrates an exploded side perspective view of the fuel type information system of FIG. 1.

FIG. 3 illustrates a longitudinal cross sectional view of the fuel type information system of FIG. 1.

FIG. 4 illustrates a top view of the fuel type information collar of the fuel type information system of FIG. 1.

FIG. 5 illustrates a side view of the fuel type information collar of FIG. 1.

FIG. 6 illustrates a cross sectional view of the fuel type information collar of FIG. 1.

FIG. 7 illustrates a second embodiment of the fuel type information collar. The plurality of finger cuts cut partially into the fuel type information collar, forming scores that separate upon installation over the fuel tank filler pipe assembly.

FIG. 8 is a flowchart of a method for installing the fuel type information system of FIG. 1.

### DETAILED DESCRIPTION

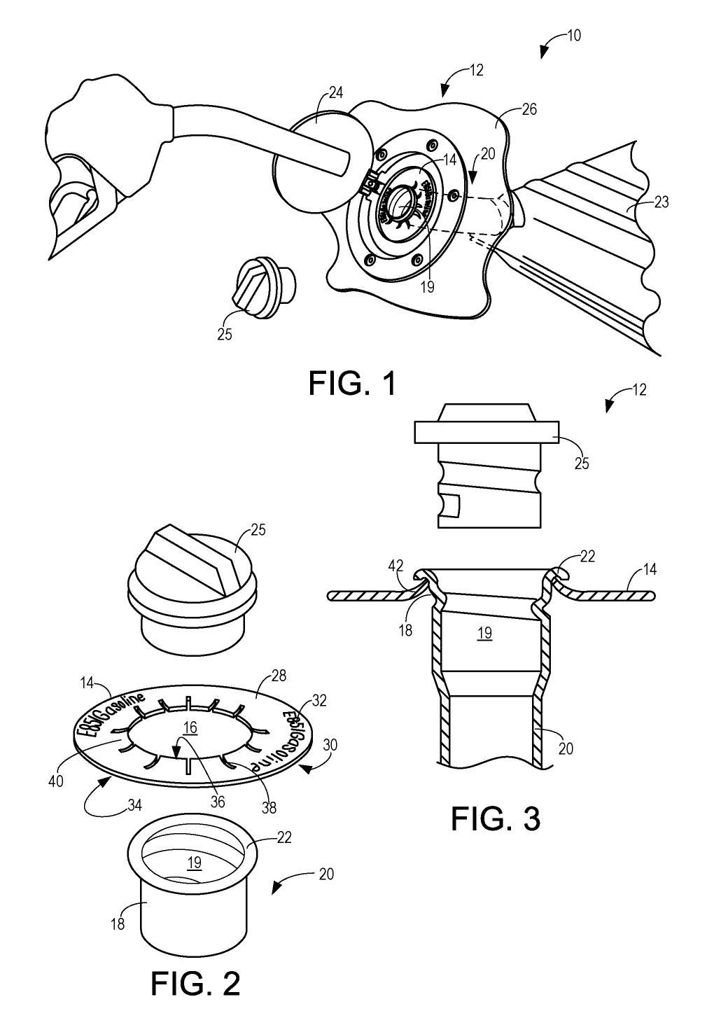

FIG. 1 illustrates a fuel type information system 12 of an automotive vehicle 10, the fuel type information system 12 for indicating to a driver type of fuel to be used by the automotive vehicle 10. The fuel type information system 12 may include a fuel tank filler pipe assembly 20 for filling fuel into a fuel tank 23 of the automotive vehicle 10, and a fuel type information collar 14 configured to engage an outer perimeter 18 of an inlet 19 of the fuel tank filler pipe assembly 20, in some examples and as is better shown in FIG. 3, just under a ridge or lip 22 of the fuel tank filler pipe 20.

The fuel type information system 12, being positioned at the inlet 19 of the fuel tank filler pipe assembly 20, behind a fuel door 24 located on a body 26 of the automotive vehicle, the fuel type information system 12 may be located at a point of view of a driver when he/she opens a fuel door 24 and detaches the fuel cap 25 to add fuel into a fuel tank 23.

The fuel type information collar 14 may be suitable shape allowing it to engage the outer perimeter 18 of the inlet 19 of the fuel tank filler pipe assembly 20. For example, the fuel type information collar 14 may be shaped in form a disk having a center through aperture 16 (better illustrated in FIG. 2 & 4) configured to engage the outer perimeter 18 of the inlet 19 of the fuel tank filler pipe assembly 20. By forming the fuel type information collar 14 in a disk shape with a center hole, it may have increased manufacturability of the fuel type information collar 14, for example through an injection molding process.

As is shown in FIG. 2, the fuel type information collar 14 may include an inner perimeter 36 defining the aperture 16 for engaging the fuel tank filler pipe assembly 20. The inner perimeter 36 may be substantially circular, or may have any other suitable contour that enables the fuel type information collar 14 to engage the fuel tank filler pipe assembly 20, such as oval, square, rectangular, etc. The inner perimeter 36 may be sized to fit over and engage the outer perimeter 18 of the inlet 19 of the fuel tank filler pipe 18. For example, the inner perimeter 36 may be a substantially circular and it may have a diameter that is substantially identical or slightly smaller than the diameter of the outer perimeter 28 of the inlet 19 of the fuel tank filler pipe assembly 20 to ensure a snug fit.

The fuel type information collar 14 may include a top surface 28 that includes indicia 32 containing fuel type information for indicating type of fuel to be used by the automotive vehicle 10. The indicia 32 may be positioned near an outer perimeter 34 of the fuel type information collar 14 that defines an outer edge of the fuel type information collar 14. The indicia 32 may include markings such as, but not limited to, “E85/Gasoline”, “Diesel”, “Gasoline”, “E85”, “FVV”, and other suitable markings for indicating type of fuel to be used by the automotive vehicle 10. The indicia 32 may include logos in addition to information relating to the fuel type.

The indicia 32 may be formed on the top surface 28 via various techniques, for example printed on via a pad printing technique, etched on, formed through a single-shot injection molding process, and/or formed through a double-shot injection molding process.

The fuel type information collar 14 may additionally include a plurality of radial finger cuts 38 angularly spaced around the inner perimeter 36 of the fuel type information collar 14 forming a plurality of fingers 40 that engage the outer perimeter 34 of the inlet 19 of the fuel tank filler pipe assembly 20. In one example, the plurality of radial finger cuts 38 may include 12 radial finger cuts 38, providing 12 fingers for engaging the outer perimeter 18 of the inlet 19 of the fuel tank filler pipe assembly 20. Any other number of suitable radial finger cuts 38 may be provided in other examples.

The plurality of radial finger cuts 38 may traverse from the inner perimeter 36 radially outward, lead from and open into the aperture 16 defined by the inner perimeter 36, but end before reaching the outer perimeter 34 of the fuel type information collar 14. In one example, the plurality of radial finger cuts 38 may end midway between the inner perimeter 36 and the outer perimeter 34 of the fuel type information collar 14.

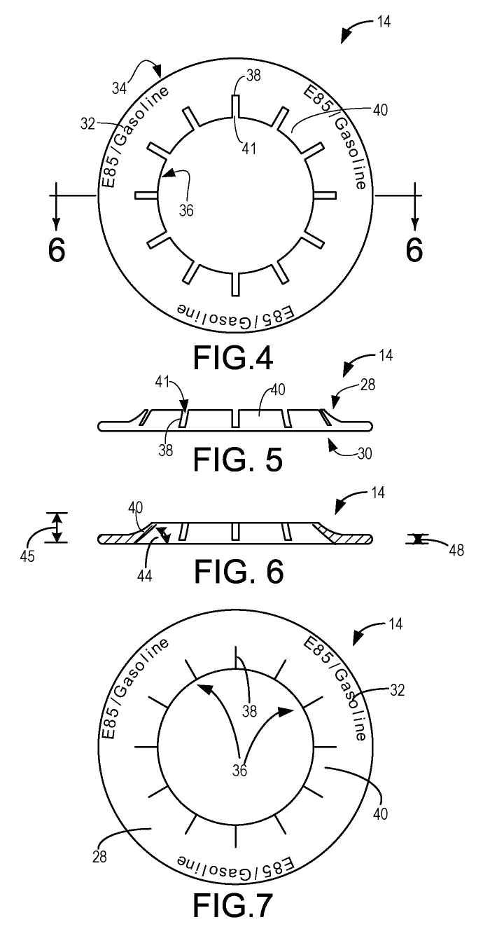

In some examples and as shown in FIG. 4, the plurality of radial finger cuts 38 may cut through the full thickness of the fuel type information collar 14, forming voids 41 at the cutting locations. In other examples and as shown in FIG. 7, the plurality of radial finger cuts 38 may cut partially into the fuel type information collar 14, so that they form scores 43 as shown in FIG. 7, that separate upon installation over the inlet 19 of the fuel tank filler pipe assembly 20.

The radial finger cuts 38 may be symmetrically and evenly spaced along the inner perimeter 36. Each of the plurality of radial finger cuts 38 may be of equal length or unequal length.

The plurality of radial finger cuts 38 may form a plurality of fingers 40 configured to engage the outer perimeter 18 of the outlet 19 of the fuel tank filler pipe assembly 20.

As shown in FIG. 4, the plurality of fingers 40 may have a width that narrows from midway between the inner perimeter 36 and the outer perimeter 34 of the fuel type information collar 14, to the inner perimeter 36.

As shown in FIGS. 5 and 6, each of the plurality of fingers 40 may curve outward from the top surface 28 to protrude above an outer perimeter 34 of the fuel type information collar 14. A lead-in angle 44 is formed as a result of the upward curving of the plurality of fingers 40. The ratio of the outward angle height 45 to the thickness 48 of the fuel type information collar 14 is more than 1.

The fuel information collar 14 may be relatively thin. In one example, the thickness 48 of the fuel type information collar 14 may be about ½ or less of the radial width of the collar, as shown by comparing FIGS. 4 and 6, for example.

Better shown in a cross sectional view of the fuel type information collar 14 illustrated in FIG. 6, the plurality of fingers may have a thickness that tapers to be narrower toward the inner perimeter 36, resulting in tapered fingers. The plurality of fingers may have substantially equal widths at a given radius.

The lead-in angle 44 may enable an interference fit via the plurality of fingers 40, thereby enable the fuel type information collar 14 to be more easily installed, yet still difficult to remove. In this way the collar may be more permanently attached to the automotive vehicle 10 to reduce dislodgement. In addition, the interference fit of the plurality of fingers 40 may also keep the fuel type information collar 14 from rattling when the vehicle is moving to thereby reduce any potential noise and/or vibration.

In some examples, the fuel type information collar 14 may be engaged to an underside of the lip 22 of the inlet 19 of the fuel tank filler pipe assembly 20, with the lip 22 serving as a stop for stopping the fuel type information collar 14 from dislodgement once it is installed. The fuel type information collar 14 may be therefore permanently or semi-permanently engaged to the fuel tank filler pipe 20 so that it may not be possible, at least it would be difficult, to remove the fuel type information collar 14 from the fuel tank filler pipe assembly 20 without breaking or deforming the fuel type information collar 14.

The fuel type information collar 14 may be color coded. Thus, a black cap may be used, yet still have some color coding for indicating fuel type per SAE guidelines. For example, a yellow fuel type information collar with “E85/Gasoline” on it indicates to a driver that either E85 or unleaded gasoline may be used. A green fuel type information collar with “Diesel” on it may indicate to a driver that diesel fuel is used. Further still, other color coding may be used, and other colors may be used.

FIG. 2 illustrates an exploded perspective view of the fuel type information system 12 of FIG. 1, showing the fuel type information collar 14 having a body shaped in form of a disk with the center through hole or aperture 16 for engaging the fuel tank filler pipe 20.

FIG. 3 illustrates a longitudinal cross sectional view of the fuel type information system 12 of FIG. 1, showing the fuel type information collar 14 being engaged to the fuel tank filler pipe 20 at the mouth of the fuel tank filler pipe 20, right under the lip 22 of the fuel tank filler pipe 20.

FIG. 4 illustrates a top view of the fuel type information collar 14 of the fuel type information system 12 of FIG. 1, providing a better view of an example angular spacing 46 of the plurality of finger cuts 38 on the fuel type information collar 14. In particular, the plurality of finger cuts 38 is shown to include twelve finger cuts, providing twelve fingers for engaging the fuel tank filler pipe 20.

FIG. 5 illustrates a side view of the fuel type information collar of FIG. 1, showing the plurality of fingers curve upwards forming a lead-in angle for providing relief for installation and for providing an interference fit with the fuel tank filler pipe. The lead-in angle may range from approximately 1 degree to approximately 89 degrees. In one example, the lead-in angle may be approximately 45 degree. In another example, the lead-in angle may be between 20 and 60 degrees.

FIG. 6 illustrates a cross sectional view of the fuel type information collar of FIG. 1, showing that the plurality of fingers are tapered at the inner perimeter. The tapering may be a straight line or may be curved.

FIG. 7 illustrates second embodiment of the fuel type information collar, showing the plurality of radial finger cuts cut partially into the fuel type information collar, so that they form scores 48 that separate upon installation over the fuel tank filler pipe assembly.

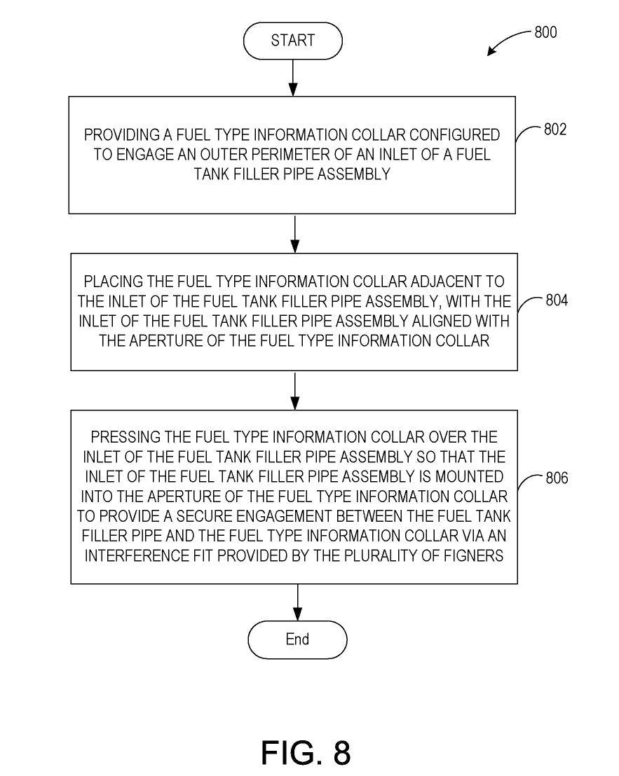

FIG. 8 illustrates a flow chart for a method 800 of assembling the fuel type information system of FIG. 1. The method may include:

At 802, the method includes providing a fuel type information collar configured to engage an outer perimeter of an inlet of a fuel tank filler pipe assembly of an automotive vehicle. For example, the fuel type information collar and various modifications thereof described herein may be used. Additionally, the vehicle assembly method may include matching appropriately color coded collars to vehicles based on the fuel types on which the vehicle may operate. For example, a first vehicle that can operate on gasoline only may include a black collar with corresponding indicia on the collar indicating “gasoline only”. Likewise, a second vehicle that can operate on gasoline and/or E85 only may include a yellow collar with corresponding indicia on the collar indicating “E85/Gasoline.” The first and second vehicle may be assembled on a common assembly line, or may be assembled at different assembly plant. Further, the assembly may further utilize a black gas cap for each of the above example vehicles, yet still have some color coding for indicating fuel type per SAE guidelines. For example, the yellow fuel type information collar with “E85/Gasoline” on it indicates to a driver that either E85 or unleaded gasoline may be used.

At 804, the method includes placing the appropriately color-coded fuel type information collar adjacent to the inlet of the fuel tank filler pipe assembly, with the inlet of the fuel tank filler pipe aligned with the aperture of the fuel type information collar.

At 806, the method includes pressing the fuel type information collar over the inlet of the fuel tank filler pipe assembly, so that the inlet of the fuel tank filler pipe assembly is mounted within the aperture of the fuel type information collar to provide a secure engagement between the fuel tank filler pipe assembly and the fuel type information collar via an interference fit provided by the plurality of fingers pressing against the outer perimeter of the inlet of the fuel tank filler pipe assembly.

In some examples, once mounted or installed, the fuel type information collar may be engaged to an underside of the lip of the inlet of the fuel tank filler pipe assembly, with the lip serving as a stop for stopping the fuel type information collar from dislodgement once it is installed.

Each of the above figures illustrates various components in various views that are drawn approximately to scale. However, the various absolute and relative dimensions of the components may be varied from those noted above, if desired.

It will be appreciated that the configurations disclosed herein are exemplary in nature, and that these specific embodiments are not to be considered in a limiting sense, because numerous variations are possible. For example, the collar may be rectangular shaped, octagonal, hexagonal, irregularly shaped, or otherwise. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A fuel type information collar configured to engage an outer perimeter of an inlet of a fuel tank filler pipe of a fuel tank filler pipe assembly of an automotive vehicle, the fuel type information collar comprising:
an inner perimeter defining an aperture configured to engage the outer perimeter of the inlet of the fuel tank filler pipe assembly;
a top surface including indicia of fuel type information for indicating type of fuel to be used by the automotive vehicle;
a plurality of radial finger cuts angularly spaced around the inner perimeter, the plurality of radial finger cuts forming a plurality of fingers that engage the outer perimeter of the fuel tank filler pipe of the fuel tank filler pipe assembly.

2. The fuel type information collar of claim 1, wherein the plurality of radial cuts traverses from the inner perimeter radially outward, but end before reaching an outer perimeter of the fuel type information collar.

3. The fuel type information collar of claim 1, wherein the plurality of radial finger cuts cut through the full thickness of the fuel type information collar and form voids at the cuts.

4. The fuel type information collar of claim 1, wherein the plurality of radial finger cuts cut partially into the fuel type information collar, so that they form scores that separate upon installation over the fuel tank filler pipe assembly.

5. The fuel type information collar of claim 1, wherein the fuel type information collar is disk-shaped and wherein the inner perimeter of the aperture of the fuel type information collar is substantially circular and is configured to engage a circular outer perimeter of a fuel tank filler pipe of the fuel tank filler pipe assembly, and wherein each of the plurality of fingers is curved outwardly from the top surface.

6. The fuel type information collar of claim 1, further comprising a substantially circular outer perimeter defining an outer edge of the fuel type information collar.

7. The fuel type information collar of claim 1, wherein the plurality of radial finger cuts includes twelve radial finger cuts forming twelve fingers for engaging the outer perimeter of the fuel tank filler pipe of the fuel tank filler pipe assembly.

8. The fuel type information collar of claim 1, wherein the plurality of fingers have a width and a thickness, and where the thickness of each of the plurality of fingers tapers to be more thin towards the inner perimeter of the fuel type information collar.

9. The fuel type information collar of claim 1, wherein the fuel type information collar is configured to be substantially permanently engaged to the fuel tank filler pipe assembly.

10. The fuel type information collar of claim 1, wherein the fuel type information collar is formed of a molded plastic.

11. The fuel type information collar of claim 1, wherein the indicia is positioned on the top surface near an outer perimeter of the fuel type information collar, and where the indicia indicates at least two acceptable fuel types.

12. The fuel type information collar of claim 1, wherein the indicia includes “E85” and “gasoline”.

13. The fuel type information collar of claim 1, wherein the indicia includes “diesel”.

14. The fuel type information collar of claim 1, wherein the indicia includes “FFV”.

15. A fuel type information system, comprising
a fuel tank filler pipe assembly of an automotive vehicle for filling fuel into a fuel tank of the automotive vehicle; and
a fuel type information collar engaged to an outer perimeter of an inlet the fuel tank filler pipe assembly, the fuel type information collar shaped in form of a disk with a center through hole, the fuel type information collar comprising:
an inner circular perimeter defining an aperture configured to engage the outer perimeter of the fuel tank filler pipe assembly;
a top surface including indicia containing fuel type information for indicating type of fuel to be used by the automotive vehicle;
a plurality of radial finger cuts angularly spaced around the inner perimeter, each of the plurality of radial finger cuts opening into the aperture defined by the inner circular perimeter, the radial finger cuts forming a plurality of fingers configured to engage the outer perimeter of the fuel tank filler pipe, where each of the plurality of fingers curves outward from the top surface to protrude above the outer perimeter, and where each of the plurality of fingers has a thickness that tapers to be more narrow toward the inner circular perimeter.

16. The fuel type information system of claim 15, wherein the inner perimeter of the fuel type information collar engages a circular outer perimeter of the fuel tank filler pipe assembly.

17. The fuel type information system of claim 16, wherein the fuel type information collar further includes a substantially circular outer perimeter defining an outer edge of the fuel type information collar.

18. The fuel type information system of claim 17, wherein the plurality of radial finger cuts includes 12 radial finger cuts to form 12 fingers for engaging the outer perimeter of the fuel tank filler pipe.

19. The fuel type information system of claim 18, wherein the plurality of fingers curves upwards to provide an interference fit for securing the fuel type information collar to the fuel tank filler pipe assembly to prevent dislodging of the fuel type information collar.

20. A method of assembling a fuel type information system, comprising:
providing a fuel type information collar configured to engage an outer perimeter of an inlet of a fuel tank filler pipe assembly of an automotive vehicle, the fuel type information collar comprising:
an inner perimeter defining an aperture configured to engage the outer perimeter of the inlet of the fuel tank filler pipe assembly;
a top surface including indicia of fuel type information for indicating type of fuel to be used by the automotive vehicle;
a plurality of radial finger cuts angularly spaced around the inner perimeter, the plurality of radial finger cuts forming a plurality of fingers that engage the outer perimeter of the fuel tank filler pipe;
placing the fuel type information collar adjacent to the inlet of the fuel tank filler pipe assembly, with the inlet of the fuel tank filler pipe aligned with the aperture of the fuel type information collar;
pressing the fuel type information collar over the inlet of the fuel tank filler pipe assembly so that the inlet of the fuel tank filler pipe assembly is mounted into the aperture of the fuel type information collar to provide a secure engagement between the fuel tank filler pipe and the fuel type information collar via an interference fit provided by the plurality of fingers pressing against the outer perimeter of the inlet of the fuel tank filler pipe assembly.

21. A fuel type information display component configured to engage an outer perimeter of an inlet of a fuel tank filler pipe of a fuel tank filler pipe assembly of an automotive vehicle, the fuel type information display component comprising:
an inner perimeter defining an aperture configured to engage at least a portion of the inlet of the fuel tank filler pipe assembly; and
an outer surface including indicia of fuel type information for indicating type of fuel to be used by the automotive vehicle, where the component is color-coded corresponding to an allowable fuel type.
